(19) United States
(12) Patent Application Publication
(10) Pub. No.: US 2026/0085556 A1
(43) Pub. Date: Mar. 26, 2026

(54) LOCK, IN PARTICULAR QUARTER-TURN LOCK

(71) Applicant: EMKA BESCHLAGTEILE GMBH & CO. KG, Velbert (DE)

(72) Inventors: Manuel Sebastian Nowak, Wuppertal (DE); Turgay Alan, Wuppertal (DE)

(21) Appl. No.: 19/110,265

(22) PCT Filed: Sep. 4, 2023
(86) PCT No.: PCT/DE2023/100640

§ 371 Date: Mar. 10, 2025

(30) Foreign Application Priority Data
Sep. 13, 2022 (DE) 10 2022 123 304.9

(51) Int. Cl. E05C 3/04; E05B 15/04

(52) U.S. Cl. CPC E05C 3/042; E05B 2015/0462

(57) ABSTRACT

In one or more arrangements, a quarter turn lock is presented having a locking shaft 3 rotatably mounted in a lock housing 2 and a spring securing device 4 for securing the locking shaft against unintentional rotation relative to the lock housing in at least one rotational position, wherein the spring securing device 4 has a spring 5 and a securing element 6 interacts with the lock housing 2 in a latching manner.

### FIELD OF THE DISCLOSURE

One or more disclosed embodiments relates to a lock, in particular a quarter turn lock, with a locking shaft rotatably mounted in a lock housing and a spring securing device for securing the locking shaft against unintentional rotation relative to the lock housing in at least one rotational position.

### OVERVIEW

Such quarter turn locks are used in various areas, such as the electrical industry, mechanical engineering, refrigeration and air conditioning technology, vehicle construction and in the private sector for locking doors, flaps, hatches, windows or similar closing elements, which are also collectively referred to below as “doors”.

In order to be able to fix the locking element to a door frame, a fixed frame, a housing or device wall or similar elements, which are also collectively referred to as “door frame” in the following, these locks have a lock housing in which a locking shaft is mounted rotatably around the lock axis of the lock so that it can rotate between an open and a closed position.

The outward-facing end of the locking shaft is used for actuation of the lock, which is why a square, a key surface, a pivoted or lever handle or a similar actuation element can be arranged at this end, for example. The opposite inner end of the locking shaft is used to connect a locking element, which is often tongue-shaped, and which is fixed to the locking shaft so that it can be moved back and forth between the open and locked positions. Usually, the locks are designed in such a way that the locking element is pivoted through an angular range of 90 degrees from the open to the closed position and vice versa, or the locking shaft is rotated accordingly.

Locks of this kind, often also referred to as quarter turns or sash fastener locks, are known from the prior art in a wide variety of configurations.

Special requirements for these locks arise in situations in which they are exposed to shaking, vibrations or similar influences. In such situations, it is important to ensure that the lock is not opened unintentionally as a result of these influences. For this purpose, there are also locks known from the prior art that have a spring securing device that is used to secure the locking shaft against unintentional turning in at least one rotational position. Usually, this secured rotational position is the closed position of the lock, so that there is no risk of unintentional opening even under strong vibration. However, such locks are usually also configured in such a way that two rotational positions, i.e. both the open and closed positions, are secured against unintentional rotation relative to the lock housing by means of the spring securing device.

Known quarter turn locks of this type, which are sometimes also referred to as security quarter turn locks, often have a two-part locking shaft, one part of which is coupled to the other part of the locking shaft via the spring securing device in such a way that the lock can only be actuated after axial displacement of one part of the locking shaft with respect to the other part of the locking shaft against the force of a tensioned spring. Such quarter turn locks are known, for example, from EP 1 712 716 A2 and WO 2009/103414 A1 and have proven themselves in the past for applications in which the locks are exposed to very strong shaking or vibration, sometimes over long periods of time. However, the corresponding quarter turn locks have a comparatively complex structure due to the two-part locking shaft.

In addition, there are also vibration-resistant quarter turn locks in which a one-piece locking shaft is secured against unintentional turning due to vibration or shaking loads by means of a spring securing device. In this type of quarter turn lock, the spring of the spring securing device has a latching element that is integrally molded onto it. When the lock is closed, this latching element engages with a counter-element on the lock housing, latching under spring force. This also makes it possible to prevent unintentional rotational movements of the locking shaft relative to the lock housing due to vibrations and the like with relatively little effort.

However, there is a certain risk with this type of lock that inhomogeneous stresses may arise within the spring having the latching element, which may lead to failure of the spring and thus of the lock after a larger number of lock actuation cycles.

The object of one or more embodiments is therefore to provide a lock with a spring securing device that is characterized by both a simple structure and a low risk of failure.

In a lock of the type mentioned at the beginning, this problem is solved by a spring securing device having a spring and a securing element that is prestressed by means of the spring and interacts with the lock housing in a latching manner.

In addition to the spring, the spring securing device has a securing element that is pretensioned via the spring and engages with the lock housing. In this way, the two functions of the spring securing device, namely its spring function on the one hand and its latching function on the other, are distributed over two separate components. This results in homogeneous stress distribution within the spring, which is why it does not risk failing even after a very large number of actuation cycles. In addition, the lock has a simple structure.

One advantageous design is to arrange the securing element on the locking shaft so that it also rotates and/or to arrange the securing element on the locking shaft so that it can be moved axially. The co-rotating arrangement of the securing element on the locking shaft results in a relative rotation between the securing element and the lock housing. This relative rotation can be used to lock the securing element with respect to the lock housing. The axial movability of the securing element results in an axial relative movement with respect to the lock housing. This axial movement can also be used to lock or unlock the securing element with respect to the lock housing.

In order to guide the linear movements of the securing element with respect to the locking shaft, a further design proposes that the securing element be connected to the locking shaft in an axially movable manner via a guide. Defined linear movements can be achieved via the guide. In addition, the wear between the locking shaft and the securing element, which is mounted on the locking shaft so that it can move axially, can be reduced. This means that even with coarser-toleranced manufacturing dimensions, for example in the field of zinc die-cast parts, a low level of wear can be achieved between the locking shaft and the securing element. This also helps to minimize the risk of the lock failing.

Another advantageous design provides for the spring to be supported on the locking shaft and to prestress the securing element with a securing force. The spring can be supported, for example, on an axial shoulder of the locking shaft. The spring can be tensioned against the axial shoulder via the securing element. The pre-stressing of the securing element creates a kind of force threshold that must first be overcome in order to allow the securing element, which is locked to the lock housing, to be turned in relation to it. This provides a high level of security against the effects of shaking or vibration, as these are not sufficient to overcome the force threshold created by the pre-stressing. In addition, the pre-stressing force can be varied by using different springs, depending on the application and the expected shaking or vibration stresses.

Furthermore, an advantageous design with regard to a simple structure of the lock is one in which the spring is designed as a spring disk, in particular as a corrugated disk, and the securing element is designed as a securing disk. The design of both the spring and the securing element as disks results in a simple construction. In addition, standard components can be used for the spring in particular, which are available on the market at low cost and are characterized by a high resistance to alternating stresses. The spring can, for example, be designed as a corrugated disk made of spring steel.

A design in which the spring and the securing element rest against each other and form a pair of disks is advantageous from a design point of view. The pair of disks can be placed on the locking shaft in a single assembly step, which results in assembly-related advantages.

One particularly advantageous design provides for the securing element to interact with the lock housing in a latching manner in a closed position and/or an open position of the lock. This results in a latching anti-rotation device. The anti-rotation device can be used in two rotational positions, namely on the one hand the open position and on the other hand the closed position of the lock. In the closed position, the anti-rotation device prevents unintentional opening of the lock. In the open position, the anti-rotation device prevents unintentional retraction of the locking element in the direction of the closed position, which could lead to a collision with the door frame when the open door is closed. In the worst case, the locking element could bend, thereby endangering the functional safety of the lock.

Another advantageous design provides that the securing element has at least one latching contour, which latches together with at least one correspondingly designed latching contour of the lock housing. Advantageously, several latching contours can be provided both on the securing element and on the lock housing. A securing effect can be achieved not only in one rotational position but in several rotational positions by means of several latching contours. Furthermore, a securing force applied symmetrically between the securing element and the lock housing is obtained by means of several latching contours that are simultaneously engaged.

One advantageous configuration provides that the locking contours are designed and arranged in such a way that they can be latched to and/or unlatched from one another by a rotational movement of the locking shaft. In this way, the rotational movement of the locking shaft can be used to latch and unlatch the locking contours. It is not necessary to actuate them in a separate step.

Another advantageous arrangement provides that the securing element is arranged to be movable against the force of the tensioning spring to disengage the latching contours.

Another advantageous arrangement provides that the latching contours of the latching element are designed as protrusions and the latching contours of the lock housing as recesses. Alternatively, however, it would also be possible for the latching contours of the lock housing to be designed as protrusions and the latching contours of the securing element to be designed as recesses. The protrusions can be designed in the manner of latching lugs that can be latched into corresponding latching recesses.

In this context, it is also advantageous if the latching contours have unlatching bevels. The unlatching bevels can be used to exploit a relative rotation of the locking shaft with respect to the housing for unlatching. The rotational movement can be used to move the securing element along the locking shaft and press it against the tensioning spring until the latching contours are axially unlatched from each other. As soon as the next recess on the lock housing is reached after the locking shaft has been turned further, the protrusion can snap into it and lock in the axial direction.

In this context, a constructively advantageous design is one in which the locking contours of the securing element and the locking contours of the lock housing have a substantially trapezoidal cross-section.

Finally, it is proposed in a further embodiment that the spring and the securing element are made of different materials. The spring can be made of a spring steel. The securing element can be made of a zinc alloy, for example a zamak alloy, in a manner advantageous for manufacturing, and can be produced in a zinc die casting process.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the disclosure that may be described herein. The contemplated embodiments are not so limited and should not be interpreted as being restricted to embodiments which address such objects of the disclosure. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in

### BRIEF DESCRIPTION OF THE DRAWINGS

Further details and advantages of a lock according to some various embodiments will be explained below with the help of the attached drawings of an example of an embodiment. The drawings show:

FIG. 1 a perspective view of a lock,

FIG. 2 a side view of the lock as shown in FIG. 1,

FIG. 3 a sectional view according to the sectional plane designated III-III in FIG. 2,

FIG. 4 a perspective exploded view of the lock according to the representation in FIG. 1,

FIG. 5 a further perspective exploded view of the lock according to the representation in FIG. 1, viewed from the other side,

FIG. 6 a perspective view (a) and a plan view (b) of the lock housing,

FIG. 7 a perspective view (a) and a plan view (b) of the securing element, and

FIG. 8 a perspective view (a) and a plan view (b) of the locking shaft.

### DETAILED DESCRIPTION

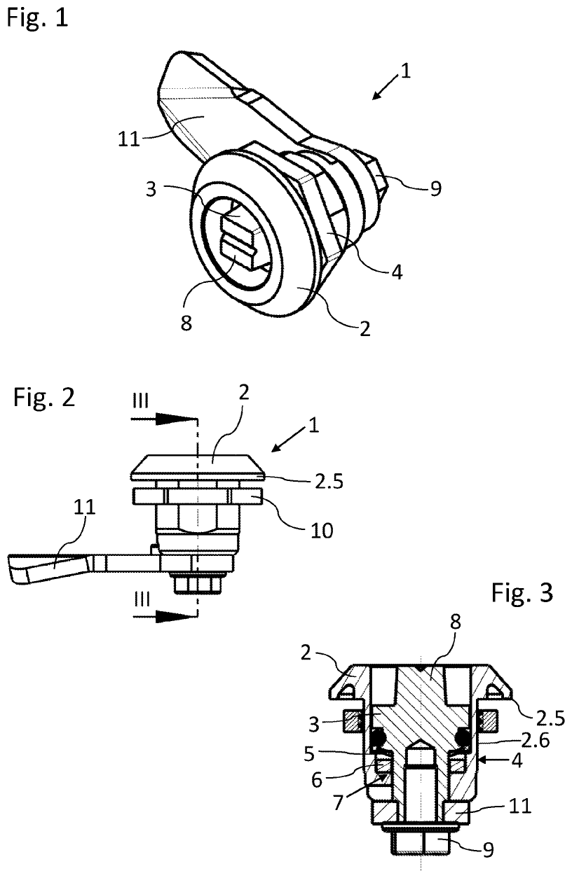

FIG. 1 shows a perspective view of a lock 1, as used in many areas of technology for locking doors to door frames.

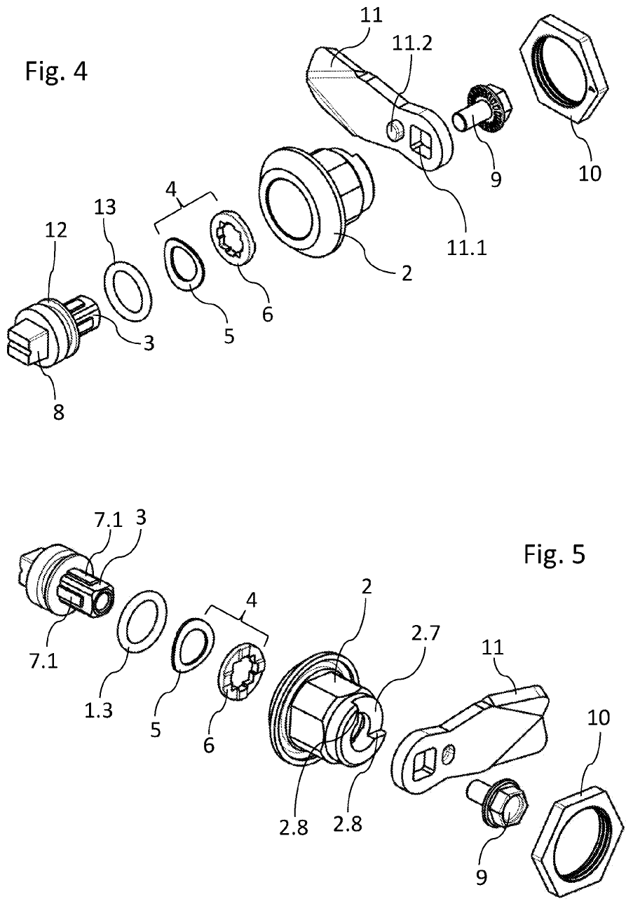

The lock 1 is a quarter turn lock, also known as a quarter turn. The lock 1 has a cylindrical lock housing 2 that can be inserted into an opening in a door not shown in the figures. To attach the quarter turn lock 1 to the door, the lock housing 2 has a collar 2.5 that rests on one surface of the door. Furthermore, the lock housing 2 has a threaded section 2.6, which is inserted through the opening in the door and on which a nut 10 can be screwed from the other side, see also FIG. 4.

A locking shaft 3, which is designed in the manner of an actuating bolt, is rotatably mounted in lock housing 2. The locking shaft 3 is designed in one piece. The locking shaft 3 has an external actuating end and an internal locking end.

An actuation device 8 is provided on the external actuating end of the locking shaft 3. The actuation device 8 is a square rod. The square rod is formed in one piece with the locking shaft 3. A suitable tool can be attached to the actuation device 8 and the locking shaft 3 can be turned by means of this.

A locking element 11 is arranged at the inner end of the locking shaft 3. In the area where it connects to the locking element 11, the locking shaft 3 has a substantially square cross-section, which can be inserted into a correspondingly square receiving opening 11.1 in the locking element 11. In order to secure the locking element 11 to the locking shaft 3, a screw bolt 9 is screwed into the locking shaft 3 coaxially with the center axis thereof and the locking element 11 is fixed to the locking shaft 3 in a manner such that it can be turned with the locking shaft 3.

As can also be seen from the illustrations in FIG. 4 and FIG. 5, the locking element 11 is a locking tongue. In addition to the receiving opening 11.1, the locking element 11 has a stop 11.2. The stop 11.2 projects in the direction of the lock housing 2 and engages in an opening 2.7 in the lock housing 2, on the sides of which two stops 2.8 are provided at 90-degree intervals. The stops 2.8 interact with the stop 11.2 in such a way that the locking shaft 3 can only be turned 90 degrees. In this case, one stop 2.8 corresponds to the open position of lock 1 and the other stop 2.8 corresponds to the closed position of lock 1.

For the purpose of dust protection, a sealing receiver 12 is provided on the locking shaft 3 in the area of the actuation device 8, in which a sealing ring 13 can be arranged, see FIG. 4. The sealing receiver 12 is a groove that opens radially outwards. The sealing ring 13 is an O-ring.

In order to protect the locking shaft 3, which is rotatably mounted in the lock housing 2, against unintentional rotation with respect to the lock housing 2 under the influence of external influences such as shaking or vibration, the lock 1 has a spring securing device 4, see also the illustration in FIG. 3. The locking shaft 3 is secured against unintentional turning both in the open position of lock 1 and in the closed position of lock 1 by means of spring securing device 4. This results in a position securing in two turning positions.

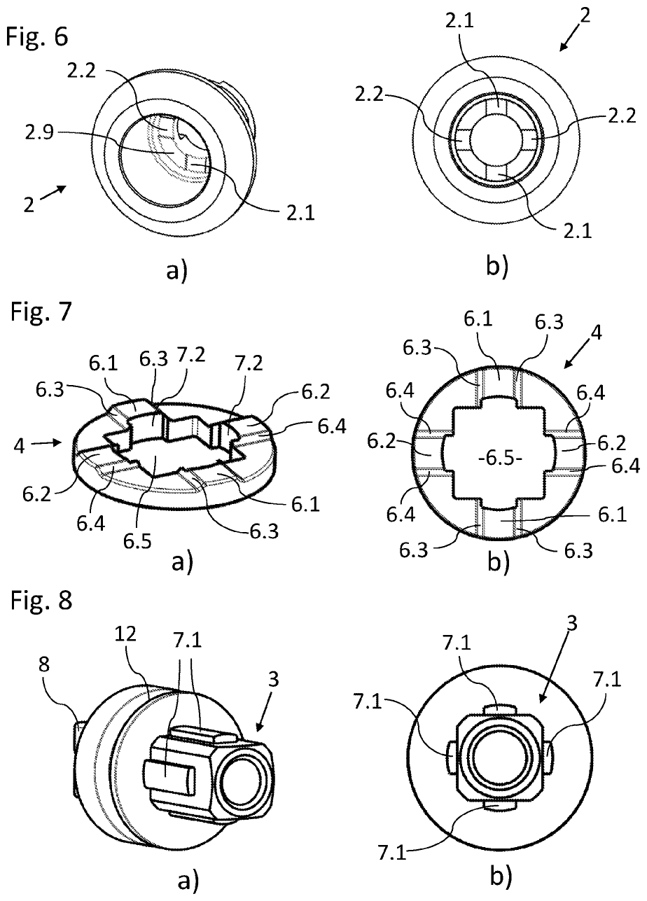

Details of the spring securing device 4 will be explained below, with particular reference to the illustrations in FIG. 4 to FIG. 8.

The spring securing device 4 has a spring 5 designed like a spring disk and a securing element 6 designed like a securing disk, see the illustration in FIG. 4 and FIG. 5.

The spring 5 is a corrugated disk made of spring steel. The spring 5 rests against the securing element 6 from the back of the latter. The spring 5 prestresses the securing element 6 in the direction of a base 2.9 of the lock housing 2. The disk-shaped spring 5 and the disk-shaped securing element 6 form a pair of disks that can be mounted on the locking shaft 3 in a single assembly step. The securing element 6 is arranged on the locking shaft 3 so that it can move axially.

A guide 7 is used to guide the axial movements of the securing element 6 with respect to the axially fixed locking shaft 3. The guide 7 can be designed as a linear guide or as an axial guide. The guide 7 has guide elements 7.1 on the locking shaft side and guide elements 7.2 on the locking element side. The guide elements 7.1 on the locking shaft side are distributed around the circumference of the locking shaft 3 at 90 degree intervals. A total of four guide elements 7.1 are provided, which extend in the axial direction of the locking shaft 3. The guide elements 7.1 end shortly before the end of the locking shaft 3, so that the locking element 11 can be pushed onto the locking shaft 3 with its receiving opening 11.1 without being obstructed by the guide elements 7.1. The securing-element-side guide elements 7.2 are formed by guide openings which can be placed over the guide elements 7.1. The guide elements 7.2 are formed on an inner opening 6.5 of the securing element 6. A total of four guide elements 7.2 are distributed at an angular distance of 90 degrees around the circumference of the opening 6.5.

Defined movements occur via the guide 7 of the securing element 6 with respect to the locking shaft 3. Furthermore, wear between the locking shaft 3 and the securing element 6 is prevented even in the event of coarser manufacturing tolerances.

This is of particular advantage in the case of the depicted embodiment, since the locking shaft 3, the securing element 6, the lock housing 2 and also the locking element 11 of the lock 1 were manufactured in a zinc die casting process in a manner advantageous in terms of manufacturing, which entails somewhat increased manufacturing tolerances. If the outside of the locking shaft 3 were to be reworked with a high degree of accuracy, for example by machining, it would also be possible to guide the movements of the securing element 6 over a square inner opening on the square outer circumference of the locking shaft 3.

On the side facing away from the spring 5, the securing element 6 has several latching contours 6.1, 6.2. The latching contours 6.1, 6.2 are designed in the form of latching protrusions that are trapezoidal in cross-section. The latching contours 6.1, 6.2 have a latching bevel 6.3, 6.4 on each side, the function of which will be explained in more detail below.

The latching contours 6.1 are offset by 90 degrees relative to the latching contours 6.2. A total of four latching contours 6.1, 6.2 are provided.

The latching contours 6.1, 6.2 interact in a latching manner with correspondingly designed latching contours 2.1, 2.2 on the base of the lock housing. The latching contours 2.1, 2.2 are arranged on the base 2.9 of the lock housing 2 opposite the securing element 6.

The following is a detailed explanation of how the lock 1 works.

When the lock 1 is in the closed position, the tongue-shaped locking element 11 rests with its nose-shaped stop 11.2 against a stop 2.8 on the housing. Therefore, from this position, the locking shaft 3 can only be turned in one direction, namely in the direction of the open position of the lock 1. In the locked position, the trapezoidal latching contours 6.1, 6.2 rest in the respective opposing latching contours 2.1, 2.2 of the lock housing 2. The securing element 6 and with it the latching contours 6.1, 6.2 are pre-stressed in the direction of the latching contours 2.1, 2.2 by means of the spring 5. For this reason, the latching contours 6.1, 6.2 cannot be easily released from the latching contours 2.1, 2.2.

To disengage the latching, it is necessary to overcome the securing force provided by the tension of spring 5. The vibrations or shocks that occur when the lock is in operation are not strong enough to do this, which is why lock 1 is resistant to unwanted rotational movements of locking shaft 3 or of the locking element 11 arranged on it.

In order to disengage the latching elements 6.1, 6.2 from the latching elements 2.1, 2.2, it is necessary to first overcome the securing force by turning the actuation device 8 of the lock 1 before the actuation device 8 can then be turned further with a lower application of force.

In this process, the unlatching bevels 6.3, 6.4 first come into contact with the leading edge of the latching contours 2.1, 2.2 in the direction of rotation. Due to the inclined position of the unlatching bevels 6.3, 6.4 with respect to the plane of rotation of the locking shaft 3, in addition to the rotational movement, there is also an axial component of movement of the securing element 6 against the force of the tensioning spring 5. The securing element 6 therefore lifts off from the base 2.9 of the lock housing 2 and, upon reaching the axial securing force, the latching contours 6.1, 6.2 disengage from the latching contours 2.1, 2.2 on the housing side. Subsequently, the locking shaft 3 can be turned further with less effort, with the latching contours 6.1, 6.2 dis-engaged from the latching contours 2.1, 2.2. Only when the open position is reached, after a rotation angle of 90 degrees, the latching contours 6.1, 6.2 of the securing element 6, which are prestressed by the spring 5, meet a matching latching contour 2.1, 2.2 on the lock housing 2. Driven by the spring 5, the latching contours 6.1, 6.2 engage in the opposing latching contours 2.1, 2.2. Since both the locking disc 6 and the lock housing 2 are made of a metallic material, this engagement can also be perceived acoustically by the user.

In the open position, the lock 1 is then also secured against unintentional turning. When moving the lock 1 from the open position to the closed position, the processes are analogous.

Even though a spring securing device 4 with a securing element 6 with a total of four latching contours 6.1, 6.2 and a housing 2 with likewise four correspondingly designed latching contours 2.1, 2.2 has been described above, a different number of latching contours is also conceivable. For example, it would also be sufficient to provide only one latching contour 6.1 on the securing element 6 and two latching contours 2.1, 2.2 on the housing 2. In this way, it would also be possible to secure the locking shaft 3 in two rotational positions relative to the housing 2. The advantage of the design described here, with four latching contours 6.1, 6.2, 2.1, 2.2 in each case, lies in the symmetrical transmission of the spring preload generated by the spring 5 via the securing element 6 to the lock housing 2. Due to the larger number of latching contours 6.1, 6.2, 2.1, 2.2, there are also correspondingly several contact points, which leads to favorable wear behavior. In addition, other numbers and arrangements of the latching contours 6.1, 6.2, 2.1, 2.2 would also be conceivable, for example, to secure a locking element 11 in a further rotational position, for example, an intermediate position between the open and closed position, via the spring securing device 4, or similar.

The quarter turn lock 1 described above is characterized by a reliable protection against unwanted rotation even with strong vibrations or shaking. In addition, the separation of the latching and spring function achieves a construction that does not have a risk of failing even under high load cycles.

### REFERENCE SIGNS

1 Lock
2 Lock housing
2.1 Latching contour
2.2 Latching contour
2.3 Latching bevel
2.4 Latching bevel
2.5 Collar
2.6 Threaded section
2.7 Housing opening
2.8 Stop
2.9 Base
3 Locking shaft
4 Spring securing device
5 Spring
6 Securing element
6.1 Latching contour
6.2 Latching contour
6.3 Unlatching bevel
6.4 Unlatching bevel
6.5 Opening
7 Guide
7.1 Guide element
7.2 Guide element
8 Actuation device
9 Screw bolt
10 Nut
11 Locking element
11.1 Receiving opening
11.2 Stop
12 Sealing receiver
13 Sealing ring

1. A lock, in particular a quarter turn lock, comprising a locking shaft rotatably mounted in a lock housing and a spring securing device for securing the locking shaft against unintentional rotation with respect to the lock housing in at least one rotational position;
wherein the spring securing device has a spring and a securing element which is prestressed by means of the spring and interacts in a latching manner with the lock housing.

2. A lock according to claim 1, characterized in that the securing element is arranged on the locking shaft so that it rotates with it and/or in that the securing element is arranged on the locking shaft so that it can be moved axially.

3. A lock according to claim 1, characterized in that the securing element is connected to the locking shaft via a guide so that it can be moved axially.

4. A lock according to claim 1, characterized in that the spring is supported on the locking shaft and prestresses the securing element with a securing force.

5. A lock according to claim 1, characterized in that the spring is designed as a spring disk, in particular as a corrugated disk, and the securing element is designed as a securing disk.

6. A lock according to claim 5, characterized in that the spring and the securing element rest against one another and form a pair of disks.

7. A lock according to claim 1, characterized in that the securing element interacts in a latching manner with the lock housing in a closed position and/or an open position of the lock.

8. A lock according to claim 1, characterized in that the securing element has at least one latching contour which latches together with at least one correspondingly designed latching contour of the lock housing.

9. A lock according to claim 8, characterized in that the latching contours are designed and arranged in such a way that they can be latched to and/or unlatched from one another by a rotational movement of the locking shaft.

10. A lock according to claim 9, characterized in that the securing element is arranged such that it can be moved against the force of the spring in order to disengage the latching contours.

11. A lock according to claim 8, characterized in that the latching contours of the securing element are designed as protrusions and the latching contours of the lock housing are designed as recesses.

12. A lock according to claim 8, characterized in that the latching contours have unlatching bevels.

13. A lock according to claim 8, characterized in that the latching contours and the latching contours have a substantially trapezoidal cross section.

14. A lock according to claim 1, characterized in that the spring and the securing element are made of different materials.

15. A lock according to claim 1, wherein the spring is configured to prestress the securing element in a manner which causes homogeneous stress distribution within the spring.

16. A quarter turn lock, comprising:
a lock housing;
a locking shaft rotatably mounted in the lock housing;
a spring securing device for securing the locking shaft against unintentional rotation with respect to the lock housing in at least one rotational position;
wherein the spring securing device has a spring and a securing element which is prestressed by means of the spring and interacts in a latching manner with the lock housing;
wherein the securing element is arranged on the locking shaft so that it rotates with it; and
wherein the securing element is connected to the locking shaft via a guide so that it can be moved axially.

17. The lock of claim 16, wherein the spring and the securing element rest against one another and form a pair of disks;
wherein the spring is designed as a spring disk, in particular as a corrugated disk, and the securing element is designed as a securing disk.

18. The lock of claim 16, further comprising a set of latching contours including at least one latching contour of the securing element and at least one latching contour of the lock housing;
wherein the set of latching contours are designed and arranged in such a way that they can be latched to and/or unlatched from one another by a rotational movement of the locking shaft;
wherein the set of latching contours is arranged such that it can be moved against the force of the spring in order to disengage the set of latching contours.

19. The lock of claim 16, further comprising a set of latching contours including at least one latching contour of the securing element and at least one latching contour of the lock housing;
wherein the latching contours of the securing element are designed as protrusions and the latching contours of the lock housing are designed as recesses.

20. The lock of claim 16, further comprising a set of latching contours including at least one latching contour of the securing element and at least one latching contour of the lock housing;
wherein the set of latching contours have a substantially trapezoidal cross section.
